(19) United States
(12) Patent Application Publication
(10) Pub. No.: US 2017/0293047 A1
(43) Pub. Date: Oct. 12, 2017

(54) METHOD OF DETERMINING THE COAL-BEARING SYSTEM BOUNDARY

(71) Applicants: Shandong University of Science and Technology, Qingdao (CN); Shandong Provincial Coal Geological Planning, Exploration and Research Institute, Jinan (CN)

(72) Inventors: Zengxue LI, Qingdao (CN); Ying LI, Qingdao (CN); Dawei LV, Qingdao (CN); Huaihong WANG, Qingdao (CN); Dongdong WANG, Qingdao (CN); Pingli WANG, Qingdao (CN); Haiyan LIU, Qingdao (CN)

(73) Assignees: Shandong University of Science and Technology, Qingdao (CN); Shandong Provincial Coal Geological Planning, Exploration and Research Institute, Jinan (CN)

(21) Appl. No.: 15/478,626

(22) Filed: Apr. 4, 2017

(30) Foreign Application Priority Data
Apr. 8, 2016 (CN) 201610217013.3

(51) Int. Cl. G01V 9/00

(52) U.S. Cl. CPC G01V 9/00

(57) ABSTRACT

A method of determining the coal-bearing system boundary includes the following steps: firstly, determining the high-level boundaries mainly including the tectonic boundary, ore-bearing stratum and geological body distribution boundary, mixed complex boundary, etc.; secondly, determining the major boundary mainly including a fault or fault zone, giant fold or fold assemblage zone, sedimentary boundary, stratigraphic and mineral occurrence boundary, natural geography and artificial boundary, etc.. The determination of each major boundary contains the definition of its interfaces or boundaries with specific meaning among 18 types of such interfaces or boundaries. The coal-bearing system boundary is determined based on the features of the boundaries with specific meaning as well as the boundary development, mineral assemblage and spatial distribution conditions of a specific region. Among these types of boundaries, some boundaries with specific meaning are the necessary conditions for determining the coal-bearing system boundary, while some boundaries are optional conditions.

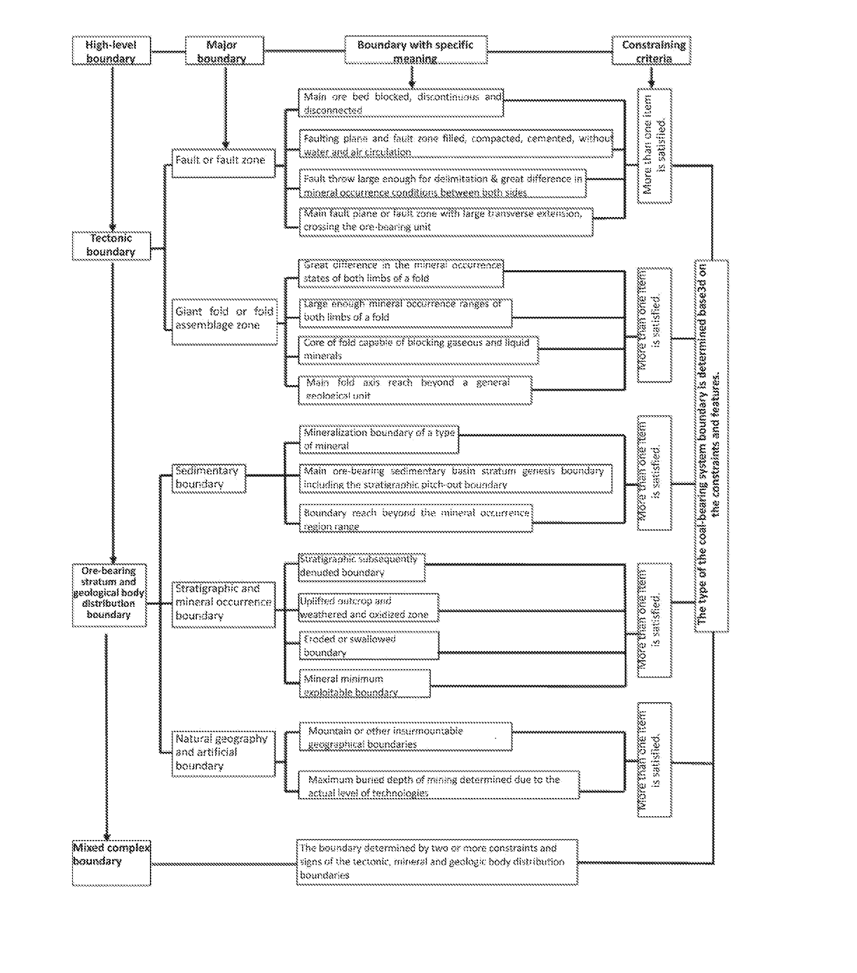

### TECHNICAL FIELD

The present invention relates to a method of determining the coal-containing system boundary, and more particularly to a method of classifying, identifying and determining the boundary type of a coal-bearing system.

### BACKGROUND

The contents involved in the research on the coal-bearing system are very extensive, especially since the research on the coalbed methane reservoirs and coal-measure free gas reservoirs has become a hot issue, the coal geological research has been no longer a pure research on coal formation and the environment, coal accumulation basin and coal accumulation laws, but become a comprehensive study and a systematic process of collaborative research between the coal geology-related disciplines. Therefore, the construction of the coal-bearing system must overcome the singleness defect of the previous coal field geological research, prospecting and coal exploitation and so on.

The geological elements of a coal-bearing system mainly include the coal measure, coal seam (group), roof rock, floor rock, coal-measure free gas reservoir rock and cap rock as well as coal-measure overlying rock and other static factors. It should also include the tectonic evolution, accumulation and flow of water entering the coal measure and coal seam, coal measure free gas migration, coalbed methane adsorption and analytical dynamics balance and other dynamic factors. Coal measure and coal seam (group) are the main bodies of a coal-bearing system, and the coal measure, also known as coal-bearing rock series, is a sedimentary rock series, the genesis of which has the symbiotic relationship and which contains coal seam (or coal line). Its synonyms include coal-bearing deposit, coal-bearing stratum and coal bearing formation. The coal-bearing rock series is a sedimentary entity with a three-dimensional spatial morphology and especially refers to a set of sedimentary rock series containing coal seams and it is a sedimentary population with a symbiotic relationship in coal-bearing basins. The top and bottom interfaces of coal-bearing rock series are not necessarily chronostratigraphic interfaces but may be chronostratigraphic or not. All factor analysis is carried out closely around the formation and the spread law of the coal seam (group). The coal seam is the main body to assess the potential of resources, but also the carrier of coalbed methane. In addition, the geological elements should also include magmatic rock distribution, karst collapse and so on.

Only the description above is far from enough and the boundary conditions are very important to a system in addition to the internal structure. However, there are still no scientific and effective methods of determining the coal-bearing system boundary at home and abroad at present, which brings many uncertainties.

### SUMMARY OF THE DISCLOSURE

In view of the technical problem above, the disclosure provides a method of determining the coal-bearing system boundary.

The technical solution adopted by the disclosure is:

A method of determining the coal-bearing system boundary, wherein it comprises the following steps:

firstly, determine the level of the coal-bearing system boundary and categorize and define the boundaries into the high-level boundary, major boundary and boundary with specific meaning according to their natures;

The high-level boundary refers to the major-category boundary, or is called attribute boundary and includes the tectonic boundary, ore-bearing stratum and geological body distribution boundary and mixed complex boundary;

The major boundary refers to the main boundary type for delimiting the coal-bearing system, or is called critical boundary and serves as the main basis for delimiting the coal-bearing system, as long as the major boundary is determined, the spatial framework and nature, features and basic ore bearing rules of the coal bearing system are almost established and such type of boundary includes the fault or fault zone, giant fold or fold assemblage zone, sedimentary boundary, stratigraphic and mineral occurrence boundary, natural geography and artificial boundary;

The determination of each major boundary contains the definition of its interfaces or boundaries with specific meaning.

The specific steps are as follows:

A. High-level boundary: Firstly, determine the major category that the highest level of coal-bearing system belongs to;

A1. Tectonic boundary: It is the main boundary major-category for delimiting and defining the coal-bearing system, has a critical meaning to delimiting the coal-bearing system and includes two major boundaries:

A1B1. Fault or fault zone: A fault or fault zone comprising a set of fracture surfaces staggers the strata or geological bodies and produces a large distance, resulting in very different natures of the geological bodies on both sides;

A1B1C1. Main ore bed blocked, discontinuous and disconnected: The fault or fault zone has the feature of blocking the main ore beds or main ore bodies on both sides so that the strata and ore bodies on both sides become discontinuous and disconnected;

A1B1C2. Faulting plane and fault zone filled, compacted, cemented, without water and air circulation: The fault plane or fault zone has been filled with substances, compacted and cemented as a whole so that the liquid and gaseous substances in the geological bodies on both sides cannot make exchange;

A1b1C3. Fault throw large enough for delimitation & great difference in mineral occurrence conditions between both sides: The fault throw of the fault or fault zone is large enough and the occurrence states and forms of the minerals in the geological bodies on both sides have great difference so that they are classified as different occurrence modes;

A1B1C4. Main fault plane or fault zone crossing the ore-bearing unit: Its reach should exceed the occurrence range of the minerals within a geological unit and is sufficient to control or define the mineral assessment range;

A1B2. Giant fold or fold assemblage zone: It is a major fold, or a fold zone composed of a group of folds; the fold or fold zone is able to make the geological bodies or mineral features on both sides vary greatly;

A1B2C5. Great difference in the mineral occurrence states of both limbs of a fold: As a boundary, the mineral occurrence states and modes of both limbs are obviously different and the boundary has obvious division function;

A1B2C6. Large enough mineral occurrence ranges of both limbs of a fold: As an independent coal-bearing system, the mineral occurrence ranges of both limbs of a fold are sufficient to establish a system that includes the occurrence geological unit and future exploitation unit;

A1B2C7. Core of fold capable of blocking gaseous and liquid minerals: The fold as a boundary must have a blocking effect;

A1B2C8. Main fold axis reach beyond a general geological unit: The main fold axis reach goes beyond the range of the mineral occurrence unit and the occurrence mode is controlled or limited by the main fold axis;

A2. Ore-bearing stratum and geological body distribution boundary: The distribution of ore-bearing strata and geological bodies is the basis and prerequisite of the coal-bearing system. Therefore, the stratigraphic distribution boundary and mineral distribution boundary are important boundary types of the coal-bearing system and mainly include several types as follows:

A2B3. Sedimentary boundary: Sedimentation is the controlling factor of the original genesis of the minerals, so the sedimentary boundary is the original boundary of the coal-bearing system;

A2B3C9. Mineralization boundary of a type of mineral: Such type of mineral isn't distributed outside this boundary;

A2B3C10. Main ore-bearing sedimentary basin stratum genesis boundary including the stratigraphic pitch-out boundary: The stratigraphic pitch-out is a boundary formed due to the initial formation of sedimentation; for the strata that have no mineral occurrence, the mineral distribution is strictly limited by the strata;

A2B3C11. Boundary reach beyond the mineral occurrence region range: It here means that the mineral distribution range subject to subsequent tectonic reworking is smaller than the range of the original sedimentary boundary;

A2B4. Stratigraphic and mineral occurrence boundary: The mineral resources are the main body of a coal-bearing system and the mineral occurrence boundary is also one of the boundary types of the coal-bearing system;

A2B4C12. Stratigraphic subsequently denuded boundary: The boundary experienced successive tectonic movement and stratigraphic uplift, was denuded and then buried and the denuded boundary is different from the sedimentary boundary and serves as the direct control boundary of mineral occurrence;

A2B4C13. Uplifted outcrop and weathered and oxidized zone: After the stratum was uplifted, a zone suffered from weathering and oxidation damages so that the original value of minerals in the weathered and oxidized zone was almost lost completely, and its distribution and extension serve as one of the boundaries of the coal-bearing system;

A2B4C14. Eroded or swallowed boundary: Large-scale magma intrusion or eruption resulted in significant changes in the existing stratigraphic framework and mineral occurrence modes and especially the giant dykes can be used as the coal-bearing system boundary;

A2B4C15. Mineral minimum exploitable boundary: It is mainly for solid minerals and the boundary less than this thickness value in terms of technical conditions shall not be treated as the boundary of valuable minerals;

A2B5. Natural geography and artificial boundary: Natural geography is also one of the bases for determining the coal-bearing system boundary mainly because natural geography may lead to changes in mineral exploitation and ground technology management systems; in the region where there are no significant large tectonics but minerals may be distributed widely, the coal-bearing system boundary may be determined by taking the method of artificial delimitation according to the features of exploitation and technical conditions of mineral resources;

A2B5C16. Mountain or other insurmountable geographical boundaries: Large mountains and rivers may geographically divide a region into different areas and can be used as an important reference for determining the coal-bearing system boundary in conjunction with the mineral occurrence mode and amount of resources;

A2B5C17. Maximum buried depth of mining determined due to the actual level of technologies: Mainly in the region where the minerals occur at very deep places, it is impossible to complete the exploitation and utilization of minerals after reaching a certain depth due to the restriction of the actual level of the exploitation technologies and the depth is different for different minerals;

A3. Mixed complex boundary: In the regions where the geological and geographical conditions are complex, the type of coal-bearing system boundary is also very complex and several types of boundaries may co-exist, forming a complex coal-bearing system boundary;

A3C18. The boundary determined by two or more constraints and signs of the tectonic, mineral and geologic body distribution boundaries: If the complex interwoven boundaries occur, the coal-bearing system boundary is comprehensively determined by taking the tectonic line as the main boundary sign and making reference to other boundary signs.

wherein it further comprises the steps of determining the constraining criteria for the coal-bearing system boundary: The coal-bearing system boundary is selected and determined based on the features of the above-mentioned 18 types of boundaries with specific meaning and the boundary development, mineral assemblage and spatial distribution conditions of a specific region; among these types of boundaries, some boundaries with specific meaning are necessary conditions for determining the coal-bearing system boundary, that is, the most critical constraints, that is to say, indispensable conditions; some are optional conditions, that is, sufficient conditions, which makes you confident of success in determining the coal system boundary;

(1) Necessary conditions for determining the coal-bearing system boundary

The reach as the boundary must be equal to or greater than the spatial scope of the stratum and mineral parts;

(2) Sufficient conditions for determining the coal-bearing system boundary

For the specific signs for determining the boundary types above, as long as one sign is satisfied, the type of the coal-bearing system boundary can be determined, and if two or more conditions are satisfied, the determined boundary type is more reliable but does not require that all features are met; a necessary condition and a sufficient condition can determine the coal-bearing system boundary.

The beneficial technical effect of the disclosure is:

The disclosure can accurately determine the coal-bearing system boundary and its main advantages are as follows:

(1) It proposes the classification of coal-bearing system boundaries, that is, total 18 types including high-level boundary and major boundary;

(2) It clearly defines the nature of coal-bearing system boundaries, such as tectonic boundary, geological body boundary and mixed boundary;

(3) It gives the constraints and options, such as sufficient conditions and necessary conditions;

(4) It gives the conceptions of boundary types with basic meaning and those with specific meaning.

The advantages above create technical and method guidance for accurate determination of the coal-bearing system boundary and resource discipline assessment, thus improving its practical value and application range.

### BRIEF DESCRIPTION OF DRAWINGS

The present invention is further described below in conjunction with the drawings and specific embodiments:

FIGURE illustrates a flow chart of a method of determining the coal-bearing system boundary of the disclosure.

### SPECIFIC EMBODIMENTS

To construct a coal-bearing system, first of all, determine the coal-bearing system boundary. The boundaries of the coal-bearing system and its subsystems is the boundary that demarcates the functions contained in a system and the functions that the system does not contain, that is to say, there must be a distinguishable boundary between each system or subsystem. Two systems separated by the boundary have important differences in some key contents such as coal seam spatial morphology and buried depth, coal structure, tectonic distribution, hydrogeological conditions, coal thermal evolution process and methane storage space which are radically different. Therefore, the coal-bearing system has specific ranges of region, stratigraphy and times which are determined based on the coal measure formation times, coal measure, coal seam distribution range, basic geological elements, coal-derived natural gas formation duration, retention time and other parameters.

Determination of coal-bearing system boundary: The determination of coal-bearing system has practical meaning and effect on the assessment and prediction of coal and its co-existing mineral resources, and the determination of the coal-bearing system boundary is the key and prerequisite for building the coal-bearing system, the boundary is the boundary that demarcates the functions contained in a system and the functions that the system does not contain, and the two systems separated by the boundaries have important differences in some key contents.

To determine whether there is a specific coal-bearing system, first of all, solve the boundary problem. The disclosure classifies and defines various coal-bearing system boundaries. The details are as shown in FIGURE.

Determination of Level of Coal-bearing System Boundary:

Firstly, determine the level of the coal-bearing system boundary and categorize and define the boundaries according to their natures.

They are divided into the high-level boundary, major boundary and boundary with specific meaning:

The high-level boundary refers to the major-category boundary, or is called attribute boundary and mainly includes the tectonic boundary, ore-bearing stratum and geological body distribution boundary, mixed complex boundary, etc.

The major boundary refers to the main boundary type for delimiting the coal-bearing system, or may also be called critical boundary and serves as the main basis for delimiting the coal-bearing system. As long as the major boundary is determined, the spatial framework and nature, features and basic ore bearing rules of the coal bearing system are almost established. Such type of boundary mainly includes the fault or fault zone, giant fold or fold assemblage zone, sedimentary boundary, stratigraphic and mineral occurrence boundary, natural geography and artificial boundary, etc.;

The determination of each major boundary contains the definition of its interfaces or boundaries with specific meaning.

Method of Determining Coal-bearing System Boundary and Specific Implementation Steps:

A. High-level boundary: Firstly, determine the major category that the highest level of coal-bearing system belongs to;

A1. Tectonic boundary: It is the first major category of the high-level category and also the main boundary major-category for delimiting and defining the coal-bearing system, has a critical meaning to delimiting the coal-bearing system and includes two major boundaries:

A1B1. Fault or fault zone: A fault or fault zone comprising a set of fracture surfaces staggers the strata or geological bodies and produces a large distance, resulting in very different natures of the geological bodies on both sides; it is defined by the following boundaries with specific meaning.

A1B1C1. Main ore bed blocked, discontinuous and disconnected: The fault or fault zone has the feature of blocking the main ore beds or main ore bodies on both sides so that the strata and ore bodies (including solid, liquid, gas and other forms) on both sides become discontinuous and disconnected;

A1B1C2. Faulting plane and fault zone filled, compacted, cemented, without water and air circulation: The fault plane or fault zone has been filled with substances, compacted and cemented as a whole so that the liquid and gaseous substances in the geological bodies on both sides cannot make exchange;

A1b1C3. Fault throw large enough for delimitation & great difference in mineral occurrence conditions between both sides: The fault throw of the fault or fault zone is large enough and the occurrence states and forms of the minerals in the geological bodies on both sides have great difference so that they are classified as different occurrence modes;

A1B1C4. Main fault plane or fault zone crossing the ore-bearing unit: The reach of such major boundary should exceed the occurrence range of the minerals within a geological unit and is sufficient to control or define the mineral assessment range, that is to say, the distribution range of the boundary should be larger than that of the ore body and the range of ore body occurrence is defined by such type of boundary but excludes the boundary.

A1B2. Giant fold or fold assemblage zone: This is another major-category boundary of the tectonic boundary and it may be a major fold, or a fold zone composed of a group of folds. The fold or fold zone is able to make the geological bodies or mineral features on both sides vary greatly. It is defined by the following boundaries with specific meaning.

A1B2C5. Great differences in the mineral occurrence states of both limbs of a fold: As a boundary, the mineral occurrence states and modes of both limbs are obviously different and the boundary has obvious division function;

A1B2C6. Large enough mineral occurrence ranges of both limbs of a fold: As an independent coal-bearing system, the mineral occurrence ranges of both limbs of a fold are sufficient to establish a system that includes the occurrence geological unit, future exploitation unit, etc.;

A1B2C7. Core of fold capable of blocking gaseous and liquid minerals: The fold as a rich ore structure may be a part of the system, and such fold cannot be used as a boundary but is a part of the system. Therefore, as a boundary, it must have a blocking effect.

A1B2C8. Main fold axis reach beyond a general geological unit: The main fold axis reach goes beyond the range of the mineral occurrence unit and the occurrence mode is controlled or limited by the main fold axis;

A2. Ore-bearing stratum and geological body distribution boundary: The distribution of ore-bearing strata and geological bodies is the basis and prerequisite of the coal-bearing system. Therefore, the stratigraphic distribution boundary and mineral distribution boundary are important boundary types of the coal-bearing system and mainly include several types as follows:

A2B3. Sedimentary boundary: Sedimentation is the controlling factor of the original genesis of the minerals, so the sedimentary boundary is the original boundary of the coal-bearing system. The sedimentary boundary may be destroyed in the subsequent tectonic movement and may be recovered in conjunction with the sedimentary filling.

A2B3C9. Mineralization boundary of a type of mineral: Its example includes the original genesis boundary of energy minerals, outside which, such type of mineral isn't distributed;

A2B3C10. Main ore-bearing sedimentary basin stratum genesis boundary including the stratigraphic pitch-out boundary: The stratigraphic framework is affected by the basin filling mechanism and the stratigraphic pitch-out is a boundary formed due to the initial formation of sedimentation; for the strata that have no mineral occurrence, the mineral distribution is strictly limited by the strata;

A2B3C11. Boundary reach beyond the mineral occurrence region range: It here means that the mineral distribution range subject to subsequent tectonic reworking is smaller than the range of the original sedimentary boundary;

A2B4. Stratigraphic and mineral occurrence boundary: The mineral resources are the main body of a coal-bearing system, and a distinctive and valuable coal-bearing system cannot be formed without such resources. Therefore, the mineral occurrence boundary is also one of the boundary types of the coal-bearing system. There are many reasons for the formation of a mineral occurrence boundary, mainly including the following reasons:

A2B4C12. Stratigraphic subsequently denuded boundary: The boundary experienced successive tectonic movement and stratigraphic uplift, was denuded and then buried and the denuded boundary is different from the sedimentary boundary and serves as the direct control boundary of mineral occurrence;

A2B4C13. Uplifted outcrop and weathered and oxidized zone: After the stratum was uplifted, a zone suffered from weathering and oxidation damages so that the original value of minerals in the weathered and oxidized zone was almost lost completely, and its distribution and extension serve as one of the boundaries of the coal-bearing system; in addition, the zone must be determined in reference to the features of other boundaries.

A2B4C14. Eroded or swallowed boundary: Large-scale magma intrusion or eruption resulted in significant changes in the existing stratigraphic framework and mineral occurrence modes and especially the giant dykes can be used as the coal-bearing system boundary; such type of boundary shall be determined in reference to the extension and distribution of other boundaries.

A2B4C15. Mineral minimum exploitable boundary: The mineral thickness is a very important parameter for solid mineral. For example, there is the provision on the minimum exploitable thickness of the coal seam thickness in terms of technical conditions and the boundary less than this thickness value shall not be treated as the boundary of valuable minerals. However, such type of boundary has a lot of limitations such as the possibility of local distribution, so it must be determined in reference to the features of tectonic development and other boundaries.

A2B5. Natural geography and artificial boundary: Natural geography is also one of the bases for determining the coal-bearing system boundary mainly because natural geography may lead to changes in mineral exploitation and ground technology management systems; in the regions where there are no significant large tectonics but minerals may be distributed widely, the coal-bearing system boundary may be determined by taking the method of artificial delimitation according to the features of exploitation and technical conditions of mineral resources;

A2B5C16. Mountain or other insurmountable geographical boundaries: Large mountains and rivers may geographically divide a region into different areas and can be used as an important reference for determining the coal-bearing system boundary in conjunction with the mineral occurrence mode and amount of resources;

A2B5C17. Maximum buried depth of mining determined due to the actual level of technologies: Mainly in the region where the minerals occur at very deep places, it is impossible to complete the exploitation and utilization of minerals after reaching a certain depth due to the restriction of the actual level of the exploitation technologies. However, the depth is different for different minerals. For example, the maximum depth of mining of the solid minerals is less than that of liquid and gaseous minerals. This depth shall be determined as the case may be.

A3. Mixed complex boundary: In the regions where the geological and geographical conditions are complex, the type of coal-bearing system boundary is also very complex and several types of boundaries may co-exist, forming a complex coal-bearing system boundary;

A3C18. The boundary determined by two or more constraints and signs of the tectonic, mineral and geologic body distribution boundaries: If the complex interwoven boundaries occur, the coal-bearing system boundary is comprehensively determined by taking the tectonic line as the main boundary sign and making reference to other boundary signs.

Constraining Criteria for Determination of Coal-bearing System Boundary:

The coal-bearing system boundary is selected and determined based on the features of the above-mentioned 18 types of boundaries with specific meaning and the boundary development, mineral assemblage and spatial distribution conditions of a specific region; among these types of boundaries, some boundaries with specific meaning are necessary conditions for determining the coal-bearing system boundary, that is, the most critical constraints, that is to say, indispensable conditions; some are optional conditions, that is, sufficient conditions, which makes you confident of success in determining the coal system boundary;

(1) Necessary conditions for determining the coal-bearing system boundary

The reach as the boundary must be equal to or greater than the spatial scope of the stratum and mineral parts; on the contrary, such type of boundary may be the content of the internal interface of a system with its boundary lost. The examples include A1B1C4. main fault plane or fault zone crossing the ore-bearing unit, A1B2C8. main fold axis reach beyond a general geological unit, A2B3C11. boundary reach beyond the mineral occurrence region range, etc..

(2) Sufficient conditions for determining the coal-bearing system boundary

For the specific signs for determining the boundary types above, as long as one sign is satisfied, the type of the coal-bearing system boundary can be determined, and if two or more conditions are satisfied, the determined boundary type is more reliable but does not require that all features are met; a necessary condition and a sufficient condition can determine the coal-bearing system boundary.

In summary, the disclosure provides a method of determining the coal-bearing system boundary, which comprises the following steps: firstly, determine the high-level boundaries including the tectonic boundary, ore-bearing stratum and geological body distribution boundary, mixed complex boundary, etc.; secondly, determine the major boundary, namely, the main boundary type for delimiting the coal-bearing system, which is the critical boundary for determining the coal-bearing system, serves as the main basis for delimiting the coal-bearing system and mainly includes a fault or fault zone, giant fold or fold assemblage zone, sedimentary boundary, stratigraphic and mineral occurrence boundary, natural geography and artificial boundary, etc.. The determination of each major boundary contains the definition of its interfaces or boundaries with specific meaning and the disclosure provides 18 types of such interfaces or boundaries. The coal-bearing system boundary is determined based on the features of the boundaries with specific meaning as well as the boundary development, mineral assemblage and spatial distribution conditions of a specific region. Among these types of boundaries, some boundaries with specific meaning are the necessary conditions for determining the coal-bearing system boundary, that is, the most critical constraints, while some boundaries are optional conditions, that is, sufficient conditions, and when both necessary conditions and sufficient conditions are met, you can accurately determine the coal-bearing system boundary.

Having described in detail, those skilled in the art will appreciate that, given the disclosure herein, modification may be made to the invention without departing from the spirit of the invention concept. It is not intended that the scope of the invention be limited to the specific and preferred embodiments illustrated and described.

1. A method of determining a coal-bearing system boundary, wherein the method comprises the following steps: a) determining a level of the coal-bearing system boundary, and b) categorizing and defining the coal-bearing system boundary into a high-level boundary, major boundary or boundary with specific meaning according to nature of the coal-bearing system boundary;
the high-level boundary being a major-category boundary and comprising a tectonic boundary, ore-bearing stratum and geological body distribution boundary and mixed complex boundary;
the major boundary delimiting a coal-bearing system, or serving as a main basis for delimiting the coal-bearing system, the major boundary comprising a fault or fault zone, giant fold or fold assemblage zone, sedimentary boundary, stratigraphic and mineral occurrence boundary, natural geography and artificial boundary;
determination of each major boundary comprising a definition of interfaces or boundaries with specific meaning of the major boundary,
wherein the method comprises:
A. high-level boundary: determining a major category that the highest level of the coal-bearing system belongs to;
A1. the tectonic boundary being a main boundary major-category for delimiting and defining the coal-bearing system, and having a critical meaning to delimiting the coal-bearing system and comprising two major boundaries:
A1B1. the fault or fault zone comprising a set of fracture surfaces which staggers strata or geological bodies and produces a large distance, resulting in different natures of the geological bodies on both sides;
A1B1C1. main ore bed blocked, discontinuous and disconnected wherein the fault or fault zone blocks the main ore beds or main ore bodies on both sides so that the strata and ore bodies on both sides become discontinuous and disconnected;
A1B1C2.faulting plane and fault zone filled, compacted, cemented, without water and air circulation wherein the fault plane or fault zone has been filled with substances, compacted and cemented as a whole so that liquid and gaseous substances in the geological bodies on both sides cannot make exchange;
A1b1C3. fault throw large enough for delimitation and great difference in mineral occurrence conditions between both sides where the fault throw of the fault or fault zone is large enough and the occurrence states and forms of the minerals in the geological bodies on both sides have great difference so that they are classified as different occurrence modes;
A1B1C4. main fault plane or fault zone crossing an ore-bearing unit exceeding an occurrence range of the minerals within a geological unit and being sufficient to control or define a mineral assessment range;
A1B2. giant fold or fold assemblage zone being a major fold, or a fold zone composed of a group of folds; the giant fold or fold zone being able to make the geological bodies or mineral features on both sides vary greatly;
A1B2C5. great difference in the mineral occurrence states of both limbs of a fold being a boundary wherein the mineral occurrence states and modes of both limbs are obviously different and the boundary has obvious division function;
A1B2C6. large enough mineral occurrence ranges of both limbs of a fold being an independent coal-bearing system wherein the mineral occurrence ranges of both limbs of a fold are sufficient to establish a system that includes the occurrence geological unit and future exploitation unit;
A1B2C7. core of fold capable of blocking gaseous and liquid minerals wherein the fold as a boundary has a blocking effect;
A1B2C8. main fold axis reach beyond a general geological unit wherein the main fold axis reach goes beyond the range of the mineral occurrence unit and the occurrence mode is controlled or limited by the main fold axis;
A2. ore-bearing stratum and geological body distribution boundary wherein distribution of the ore-bearing strata and geological bodies is a basis and prerequisite of the coal-bearing system, the stratigraphic distribution boundary and mineral distribution boundary comprising:
A2B3. sedimentary boundary wherein sedimentation is a controlling factor of an original genesis of the minerals, so the sedimentary boundary is an original boundary of the coal-bearing system;
A2B3C9. mineralization boundary of a type of mineral wherein the type of mineral isn't distributed outside the mineralization boundary;
A2B3C10. main ore-bearing sedimentary basin stratum genesis boundary including the stratigraphic pitch-out boundary wherein stratigraphic pitch-out is a boundary formed due to an initial formation of sedimentation; for the strata that have no mineral occurrence, the mineral distribution being limited by the strata;
A2B3C11. boundary reach beyond the mineral occurrence region range wherein the mineral distribution range subject to subsequent tectonic reworking is smaller than the range of the original sedimentary boundary;
A2B4. stratigraphic and mineral occurrence boundary wherein the mineral resources are a main body of a coal-bearing system and the mineral occurrence boundary is also one of the boundary types of the coal-bearing system;
A2B4C12. stratigraphic subsequently denuded boundary wherein the boundary experienced successive tectonic movement and stratigraphic uplift, has been denuded and then buried and the denuded boundary is different from the sedimentary boundary and serves as a direct control boundary of mineral occurrence;
A2B4C13. uplifted outcrop and weathered and oxidized zone wherein after the stratum has been uplifted, a zone suffered from weathering and oxidation damages so that an original value of minerals in a weathered and oxidized zone was almost lost completely, and its distribution and extension serve as one of the boundaries of the coal-bearing system;
A2B4C14. eroded or swallowed boundary wherein large-scale magma intrusion or eruption resulted in significant changes in an existing stratigraphic framework and mineral occurrence modes and especially the giant dykes can be used as the coal-bearing system boundary;
A2B4C15. mineral minimum exploitable boundary for solid minerals, wherein the boundary less than this thickness value in terms of technical conditions is a boundary of valuable minerals;
A2B5. natural geography and artificial boundary wherein natural geography is one of bases for determining the coal-bearing system boundary;
A2B5C16. mountain or insurmountable geographical boundaries wherein large mountains and rivers geographically divide a region into different areas and are used as a reference for determining the coal-bearing system boundary in conjunction with the mineral occurrence mode and amount of resources;
A2B5C17. maximum buried depth of mining determined due to an actual level of technologies in a region where the minerals occur at deep places;
A3. mixed complex boundary in regions where the geological and geographical conditions are complex, the type of coal-bearing system boundary is complex and several types of boundaries optionally co-exist, forming a complex coal-bearing system boundary;
A3C18. a boundary determined by two or more constraints and signs of the tectonic, mineral and geologic body distribution boundaries wherein when complex interwoven boundaries occur, the coal-bearing system boundary is determined by taking a tectonic line as a main boundary sign and making reference to other boundary signs,
wherein the method further comprises steps of determining a constraining criteria for the coal-bearing system boundary wherein the coal-bearing system boundary is selected and determined based on features of the 18 types of boundaries with specific meaning and boundary development, mineral assemblage and spatial distribution conditions of a specific region; wherein the 18 types of boundaries comprises most critical constraints which are necessary conditions for determining the coal-bearing system boundary, and sufficient conditions,
(1) the necessary conditions for determining the coal-bearing system boundary wherein reach as the boundary equals to or is greater than a spatial scope of the stratum and mineral parts;
(2) the sufficient conditions for determining the coal-bearing system boundary wherein not all features are met.

2. (canceled)

3. (canceled)
